(19) United States
(12) Patent Application Publication
(10) Pub. No.: US 2023/0217425 A1
(43) Pub. Date: Jul. 6, 2023

(54) CROSS COMPONENT CARRIER BEAM MANAGEMENT

(71) Applicant: MEDIATEK INC., Hsin-Chu (TW)

(72) Inventors: Wei-Jen Chen, Hsin-Chu (TW); Yabo Li, San Jose, CA (US); Chong-You Lee, Hsin-Chu (TW); Jiaxian Pan, Hsin-Chu (TW); Wei-Hsuan Hsieh, Hsin-Chu (TW); Da-chun Hsing, Hsin-Chu (TW); Feng Chiu, Hsin-Chu (TW)

(21) Appl. No.: 18/083,559

(22) Filed: Dec. 18, 2022

Related U.S. Application Data
(60) Provisional application No. 63/296,006, filed on Jan. 3, 2022.

(51) Int. Cl. H04W 72/044; H04W 72/542; H04L 5/00

(52) U.S. Cl. CPC H04W 72/046; H04W 72/542; H04L 5/001

(57) ABSTRACT

A method of cross component carrier (Cross-CC) beam management is proposed. A transceiver uses multiple CCs' channel measurements to obtain a beam vector such that better performance can be achieved by utilizing wideband channel. The transceiver derives the beam vector by using the channel measurements of a set of selected CCs applied with a carrier weight factor. The transceiver utilizes beam management reference signal (BM-RS) of the set of selected CCs to derive the beam vector, e.g., an optimal beam. In one embodiment, the carrier weight factor can be the number of BM-RS REs of each CC. In another embodiment, the channel measurements can be SNR/RSRP, and the carrier weight factor can be the SNR/RSRP of each CC.

### CROSS REFERENCE TO RELATED APPLICATIONS

This application claims priority under 35 U.S.C. § 119 from U.S. Provisional Application No. 63/296,006, entitled “Cross-CC AWV-OPT,” filed on Jan. 3, 2022, the subject matter of which is incorporated herein by reference.

### TECHNICAL FIELD

The disclosed embodiments relate generally to mobile communication networks, and, more particularly, to methods for beam management for cross component carrier (Cross-CC).

### BACKGROUND

Fifth generation new radio (5G NR) is an improved radio access technology (RAT) that provides higher data rate, higher reliability, lower latency and improved system capacity. In NR systems, the terrestrial radio access network includes a plurality of base stations (BS), referred as next generation Node-Bs (gNBs), communicating with a plurality of mobile stations, referred as user equipment (UE). A UE may communicate with a base station (BS) or a gNB via the downlink and uplink. The downlink (DL) refers to the communication from the base station to the UE. The uplink (UL) refers to the communication from the UE to the base station. The 5G NR standard is developed by 3GPP. Channel State Information reference signals (CSI-RS) are utilized by UEs to measure and feedback the characteristics of a radio channel so that the UE and gNB can use correct modulation, code rate, beam forming, etc. for data transmission.

The bandwidth shortage increasingly experienced by mobile carriers has motivated the exploration of the underutilized Millimeter Wave (mmWave) frequency spectrum between 3G and 300G Hz for the next generation broadband cellular communication networks. The available spectrum of mmWave band is two hundred times greater than the conventional cellular system. The mmWave wireless network uses directional communications with narrow beams and can support multi-gigabit data rate. In principle, beam training mechanism, which includes both initial beam alignment and subsequent beam tracking, ensures that base station (BS) beam and user equipment (UE) beam are aligned for data communication. In downlink DL-based beam management (BM), the BS side provides opportunities for UE to measure beamformed channel of different combinations of BS beams and UE beams. For example, BS performs periodic beam sweeping with reference signal (RS) carried on individual BS beams. UE can collect beamformed channel state by using different UE beams and report the collected information to BS.

The essence of the beamforming technology is that an interference effect occurs between the signals sent from different antennas. The basic idea of analog beamforming is to control the phase of each transmitted signal using phase shifters. Analog beamforming affects the gain of the antenna array, thus improving the coverage. The antenna gain caused by analog beamforming partially compensates for the high millimeter wave path loss. Therefore, analog beam forming is a must for 5G millimeter-wave frequencies. In digital beamforming, the signal is pre-encoded before sent to the analog RF circuit. Digital beamforming increases cell throughput because the same physical resource block (PRB) can be used to transmit data for multiple users at the same time. Hybrid beamforming is a combination of analog and digital beamforming.

Carrier aggregation (CA) is a bandwidth-extension technology supported since the LTE-Advanced era, which can aggregate multiple component carriers (CC) for simultaneous reception. For downlink and uplink data, UE and BS use the same antennas (panel) to receive all component carriers (CCs) within the same band, and the same beam is applied to all intra-band CCs. It is desirable to use multiple CCs' channel measurements to obtain an optimal beam such that better performance can be achieved by utilizing wideband channel.

### SUMMARY

A method of cross component carrier (Cross-CC) beam management is proposed. A transceiver uses multiple CCs' channel measurements to obtain a beam vector such that better performance can be achieved by utilizing wideband channel. The transceiver derives the beam vector by using the channel measurements of a set of selected CCs applied with a carrier weight factor. The transceiver utilizes beam management reference signal (BM-RS) of the set of selected CCs to derive the beam vector, e.g., an optimal beam. In one embodiment, the carrier weight factor can be the number of BM-RS REs of each CC. In another embodiment, the channel measurements can be signal to noise ratio/reference signal received power (SNR/RSRP), and the carrier weight factor can be the SNR/RSRP of each CC.

In one embodiment, a first transceiver receives a beam management reference signal (BM-RS) transmitted from a second transceiver for reference signal measurements, wherein the first transceiver comprises an antenna array applied with analog beamforming. The first transceiver performs channel measurements based on the received BM-RS for multiple component carriers (CCs) under carrier aggregation. The first transceiver derives a beam vector from the channel measurements over a set of selected CCs, wherein the beam vector is obtained from the channel measurements for the set of selected CCs applied with a carrier weight factor of a corresponding CC. The first transceiver applies the beam vector in subsequence data reception or transmission.

Other embodiments and advantages are described in the detailed description below. This summary does not purport to define the invention. The invention is defined by the claims.

### BRIEF DESCRIPTION OF THE DRAWINGS

FIG. 1 illustrates a new radio (NR) mobile communication network for cross-component carrier (cross-CC) beam management and optimization in accordance with one novel aspect.

FIG. 2 is a simplified block diagram of a base station and a user equipment that carry out certain embodiments of the present invention.

FIG. 3 illustrates a sequence flow of an overall procedure for channel measurements and cross-CC beam management and optimization in accordance with one novel aspect.

FIG. 4 is a flow chart of method of cross-CC channel measurements and beam optimization in accordance with one novel aspect.

### DETAILED DESCRIPTION

Reference will now be made in detail to some embodiments of the invention, examples of which are illustrated in the accompanying drawings.

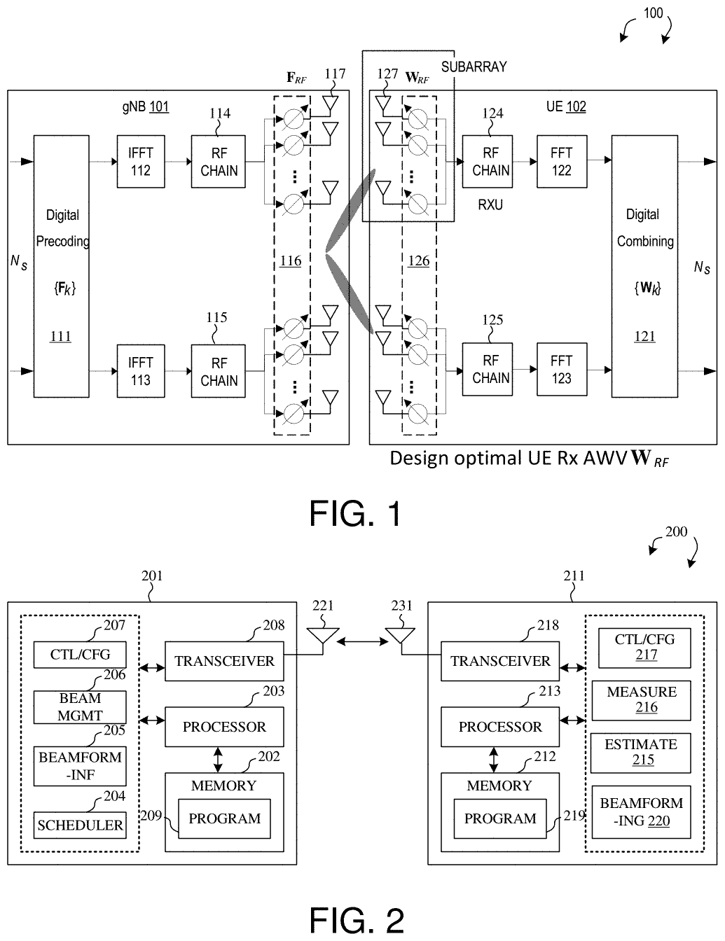

FIG. 1 illustrates a new radio (NR) mobile communication network for cross-component carrier (cross-CC) beam management and optimization in accordance with one novel aspect. Mobile communication network 100 is an OFDM network comprising a serving base station (gNB 101) and a user equipment (UE 102). In 3GPP NR system based on OFDMA downlink, the radio resource is partitioned into slots in time domain, each slot is comprised of a number of OFDM symbols. Each OFDMA symbol further consists of a number of OFDMA subcarriers in frequency domain depending on the system bandwidth. The basic unit of the resource grid is called Resource Element (RE), which spans an OFDMA subcarrier over one OFDMA symbol. A number of REs are grouped into different physical resource blocks (PRBs), where each PRB consists of twelve consecutive subcarriers in one slot.

Several physical downlink channels and reference signals are defined to use a set of resource elements carrying information originating from higher layers. For downlink channels, the Physical Downlink Shared Channel (PDSCH) is the main data-bearing downlink channel in NR, while the Physical Downlink Control Channel (PDCCH) is used to carry downlink control information (DCI). The control information may include scheduling decision, information related to reference signal information, rules forming the corresponding transport block (TB) to be carried by PDSCH, and power control command. For radio resource management (RRM) measurement in NR, each UE can be configured to measure synchronization signal (SS) blocks (SSB) and/or channel state information (CSI) reference signal (CSI-RS). For CSI-RS measurement, both frequency and timing resources need to be determined. SSB/CSI-RS can be utilized by UEs to measure the characteristics of a radio channel so that the UE can use correct modulation, code rate, beam forming, etc. for DL data reception.

The essence of the beamforming technology is that an interference effect occurs between the signals sent from different antennas. The basic idea of analog beamforming is to control the phase of each transmitted signal using phase shifters. In digital beamforming, the signal is pre-encoded before sending to the analog RF circuit. Hybrid beamforming is a combination of analog and digital beamforming, as depicted in FIG. 1. In downlink DL-based beam management (BM), the BS side provides opportunities for UE to measure beamformed channel of different combinations of BS beams and UE beams. Based on the channel measurements, an Antenna Weight Vector (AWV) for analog beam-forming and a precoding matrix for digital beamforming are calculated. In one embodiment, channel covariance information can be used for designing transmitter precoders, receiver combiners, channel estimators, etc.

In the example of FIG. 1, UE 102 is equipped with multiple RXUs (RF chains), and UE 102 is also configured with carrier aggregation (CA). Typically, for downlink data, UE 102 uses the same antennas (panel) to receive all component carriers (CCs) within the same band, and the same AWV is applied to all intra-band CCs. However, UE 102 may experience low signal to noise radio (SNR) performance and facing steering vector misalignment between different RXUs. For example, suppose there is no intrinsic phase misalignment between two RXUs (e.g., RF chains 124 and 125), the AWV (W_{RF}) of the two RXUs should be the same because the angle of arrival (AoA) of two RXUs are the same. However, one of UE RXUs couldn't train AWV well if the received signal is weaker than another RXU. For example, if the RXU0's received signal power is much smaller than RXU1's, then the AWV of RXU0 would be different from RXU1.

In accordance with one novel aspect, UE 102 uses multiple CCs' channel measurements to obtain an optimal beam such that better performance can be achieved by utilizing wideband channel. In the example of FIG. 1 for downlink, gNB 101 comprises a digital precoder 111, IFFT 112, IFFT 113, RF chain 114, RF chain 115, a plurality of phase shifters 116, and antenna array 117. Similarly, UE 102 comprises a digital combiner 121, FFT 122, FFT 123, RF chain 124, RF chain 125, a plurality of phase shifters 126, and antenna array 127. In DL-based beam management (BM), gNB 101 transmits BM-RS to UE 102. The BM-RS is pre-encoded by digital precoding (111), through IFFT processing (112-113), through RF chain processing (114-115), through phase shifting (116), and transmitted to UE 102 from the antenna array (117). At the UE side, UE 102 receives the BM-RS from the antenna array 127, through phase shifting (126), through RF chain processing (124-125), through FFT processing (122-123), and to digital combining (121) for additional processing.

In one novel aspect, upon receiving the BM-RS, UE 102 considers multiple CCs' channel measurement to obtain a beam vector, e.g., an optimal beam (an optimal UE RX AWV) (W_{RF}) The optimal UE RX AWV can then be used in subsequent DL data reception and/or uplink transmission to improve performance. More specifically, a carrier weight factor is applied the channel quality for each CC of all CCs, the combined channel quality is then used to derive the optimal W_{RF} for subsequent DL data reception and/or UL data transmission. Note that although the illustrated example is for DL beam management, it also applies to UL beam management, where gNB 101 derives an optimal beam from cross-CC channel measurements.

FIG. 2 is a simplified block diagram of a base station 201 and a user equipment 211 that carry out certain embodiments of the present invention in a mobile communication network 200. For base station 201, antenna 221 transmits and receives radio signals. RF transceiver module 208, coupled with the antenna, receives RF signals from the antenna, converts them to baseband signals and sends them to processor 203. RF transceiver 208 also converts received baseband signals from the processor, converts them to RF signals, and sends out to antenna 221. Processor 203 processes the received baseband signals and invokes different functional modules to perform features in base station 201. Memory 202 stores program instructions and data 209 to control the operations of the base station. Similar configuration exists in UE 211 where antenna 231 transmits and receives RF signals. RF transceiver module 218, coupled with the antenna, receives RF signals from the antenna, converts them to baseband signals and sends them to processor 213. The RF transceiver 218 also converts received baseband signals from the processor, converts them to RF signals, and sends out to antenna 231. Processor 213 processes the received baseband signals and invokes different functional modules to perform features in UE 211. Memory 212 stores program instructions and data 219 to control the operations of the UE.

Base station 201 and UE 211 also include several functional modules and circuits to carry out some embodiments of the present invention. The different functional modules are circuits that can be configured and implemented by software, firmware, hardware, or any combination thereof. The function modules and circuits, when executed by the processors 203 and 213 (e.g., via executing program codes 209 and 219), for example, allow base station 201 to schedule (via scheduler 204), precode (via precoder 205), encode (via MIMO encoding circuit 206), and transmit control/config information and data (via control/config circuit 207) to UE 211, and allow UE 211 to receive the control/config information and data (via control/config circuit 217), measure reference signal (via measurement circuit 216), estimate channel (via estimation circuit 215), and derives optimal beam (via beamforming circuit 220) accordingly.

In one example, BS 201 transmits BM-RS to UE 211, the BM-RS could be SSB, CSI-RS, CSI-RS for tracking (e.g., tracking reference signal TRS), PDSCH DMRS, or PUSCH DMRS (if transmitted from UE 211 to BS 201). Upon receiving the BM-RS, UE 211 performs channel measurements via measurement circuit 216, which utilizes BM-RS of all intra-band CCs. UE 211 then performs channel estimation for all CCs via estimation circuit 215. A carrier weight factor is applied in combining the channel quality of a corresponding CC. UE 211 then derives an optimal beam from the combined channel quality via the beamforming circuit 220 for DL/UL data reception/transmission.

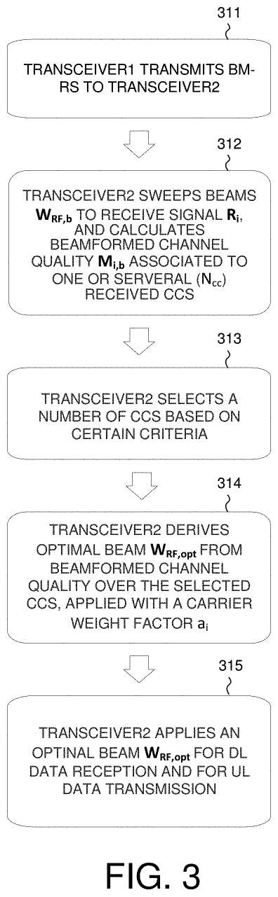

FIG. 3 illustrates a sequence flow of an overall procedure for channel measurements and cross-CC beam management and optimization in accordance with one novel aspect. In step 311, a first Transceiver1 performs beam management (BM) by transmitting BM reference signals (BM-RS) to a second Transceiver2. Transceiver2 is equipped with multiple antenna sub-arrays, a plurality of phase shifters (for analog beamforming), multiple RF chains (RXUs), and a digital combining circuit (for digital beamforming) for data reception. Transceiver2 is also configured with multiple component carriers (CCs) for data transmission under carrier aggregation (CA). In one example, Transceiver1 is a base station, Transceiver2 is a UE, the beam management is downlink BM; in another example, Transceiver1 is a UE, Transceiver2 is a base station, the beam management is uplink BM. The BM-RS can be a synchronization signal (SS) block (SSB), a channel state information reference signal (CSI-RS), a CSI-RS for tracking, a Physical Downlink Shared Channel (PDSCH) Demodulation Reference Signal (DMRS), or a Physical Uplink Shared Channel (PUSCH) Demodulation Reference Signal (DMRS).

In step 312, Transceiver2 receives the BM-RS from Transceiver1 and performs channel measurements and channel estimation accordingly. In one embodiment, Transceiver2 sweeps beam W_{RF,b} to receive signal Rᵢ using RX beam b over i^{th} CC, and calculates beamformed channel quality M_{i,b} associated to one or several (N_{cc}) received CCs.

M_{i,b}=f₁(W_{RF,b},Rᵢ)

### Where

i=0, 1, . . . , N_{CC}−1 is the index of CC

b=0, 1, . . . , N_{Beam}−1 is the index of RX beam

N_{cc} is the total number of CCs under CA

N_{Beam} is the total number of RX beams

In step 313, Transceiver2 selects a number of CCs based on certain criteria for beam management and optimization calculation. For example, the criteria may include at least one of a CC with less index value, a CC with better or weaker channel quality (based on SNR/RSRP), and a CC having more uplink and downlink (UL/DL) intersection. Note that the order of step 312 and step 313 may be reversed, especially if the CC selection criteria does not depend on channel measurements.

In step 314, Transceiver2 derives (e.g., based on a function f₃) a beam vector, e.g., an optimal beam W_{RF,opt} from beamformed channel quality M_{combine} over the selected number of CCs, and M_{combine} is a function (f₂) of carrier weight factor aᵢ and beamformed channel quality M_{i,b}:

$${M}_{combine} = {f}_{2} ( \begin{matrix}{M}_{0 , 0} , … , {M}_{0 , {N}_{Beam} - 1} , … , \\ {M}_{{N}_{CC} - 1 , 0} , … , {M}_{{N}_{CC} - 1 , {N}_{Beam} - 1} , \\ {a}_{0} , … , {a}_{{N}_{CC} - 1}\end{matrix} ) \\ {W}_{RF , opt} = {f}_{3} ( {M}_{combine} )$$

### Where

M_{i,b} is the beamformed channel quality for RX beam b over i^{th} CC
aᵢ is the carrier weight factor for i^{th} CC
M_{combine} is the beamformed channel quality over the selected number of CCs

The channel quality M_{i,b} are determined based on channel measurements. In a first example, the channel measurements on a CC are associated with an indicator related to a channel quality of the CC. In a second example, the channel measurements on a CC are based at least on one of a signal to noise ratio (SNR), a reference signal received power (RSRP), a signal-to-noise and interference (SINR), a throughput, a bit error rate, a block error rate, an interference power, a noise power, a beamforming gain, a mutual information, a receive signal strength indicator (RSSI), a reference signal received quality (RSRQ), and a received signal code power (RSCP) of the corresponding CC.

The carrier weight factor (aᵢ) for CCᵢ could be a function of one or more of the following items: a number of received BM-RS resource elements (REs) of the i-th CC (N_{RE,i}), a number of received Physical Downlink Shared Channel (PDSCH) Demodulation Reference Signal (DMRS) resource elements (REs) of the i-th CC, a signal to noise ratio (SNR) of the i-th CC, a reference signal received power (RSRP) of the i-th CC, and any other indicator related to a channel quality of the i-th CC. In step 315, Transceiver2 applies the beam vector, e.g., the optimal beam W_{RF,opt} for subsequent DL data reception and/or UL data transmission.

Note that traditionally, the carrier weight factor is proportional to the maximum PDSCH bandwidth of each corresponding CC, the reason is to favor the CC with larger PDSCH bandwidth. However, if UE sees RXU imbalance from the CC with larger PDSCH bandwidth, then such design would still favor the CC with larger bandwidth. In accordance with one novel aspect, the proposed carrier weight factor is proportional to the number of BM RS REs of each corresponding CC. In the example of FIG. 3, the carrier weight factor is equal to

$$\frac{{N}_{RE , i}}{{N}_{RE}} ,$$

where N_{RE,i} is number of BM RS REs of the i^{th} CC, and N_{RE}=Σᵢ₌₀^{N}^{_{cc}}⁻¹N_{RE,i} is the total number of BM-RS REs.

In one embodiment, an optimal beam, e.g., AWV, can be obtained using BM-RS for data reception and transmission in accordance with one novel aspect. In 3GPP NR system based on OFDMA downlink, the radio resource is partitioned into slots in time domain, each slot is comprised of a number of OFDM symbols. Each OFDMA symbol further consists of a number of OFDMA subcarriers in frequency domain depending on the system bandwidth. For downlink channels, the PDSCH is the main data-bearing downlink channel in NR, while the PDCCH is used to carry downlink control information. For radio resource management (RRM) measurement, UE is configured to measure SSB and/or CSI-RS. For DL-based BM, the BS side provides opportunities for UE to measure beamformed channel of different combinations of BS beams and UE beams.

In one example of DL beam management, gNB transmits BM-RS in predefined OFDM symbols in slot n. upon receiving the BM-RS, the UE considers multiple CCs' channel measurements obtain an optimal UE RX AWV (W_{RF,opt}). The optimal UE RX AWV can then be used in subsequent DL data reception to improve performance. For example, W_{RF,opt} can be used by the UE for analog beamforming for downlink data reception in slot n+X, slot n+X+1, and so on so forth. More specifically, a carrier weight factor proportional to the number of BM-RS REs of a corresponding CC is applied to the measured channel quality, which is then used to derive the optimal W_{RF,opt}. Similar example can be applied in uplink beam management.

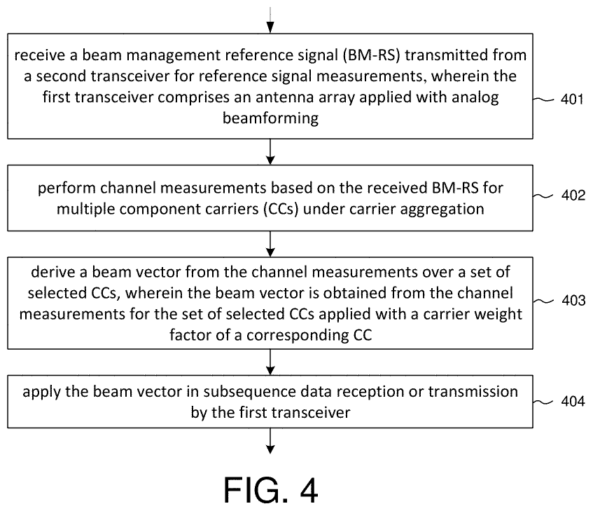

FIG. 4 is a flow chart of method of cross-CC channel measurements and beam optimization in accordance with one novel aspect. In step 401, a first transceiver receives a beam management reference signal (BM-RS) transmitted from a second transceiver for reference signal measurements, wherein the first transceiver comprises an antenna array applied with analog beamforming. In step 402, the first transceiver performs channel measurements based on the received BM-RS for multiple component carriers (CCs) under carrier aggregation. In step 403, the first transceiver derives a beam vector from the channel measurements over a set of selected CCs, wherein the beam vector is obtained from the channel measurements for the set of selected CCs applied with a carrier weight factor of a corresponding CC. In step 404, the first transceiver applies the beam vector in subsequence data reception or transmission.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving, by a first transceiver, a beam management reference signal (BM-RS) transmitted from a second transceiver for reference signal measurements, wherein the first transceiver comprises an antenna array applied with analog beamforming;
performing channel measurements based on the received BM-RS for multiple component carriers (CCs) under carrier aggregation;
deriving a beam vector from the channel measurements over a set of selected CCs, wherein the beam vector is obtained from the channel measurements for the set of selected CCs applied with a carrier weight factor of a corresponding CC; and
applying the beam vector in subsequence data reception or transmission by the first transceiver.

2. The method of claim 1, wherein the BM-RS is one of a synchronization signal (SS) block (SSB), a channel state information reference signal (CSI-RS), a CSI-RS for tracking, a Physical Downlink Shared Channel (PDSCH) Demodulation Reference Signal (DMRS), and a Physical Uplink Shared Channel (PUSCH) DMRS.

3. The method of claim 1, wherein the set of selected CCs is based on at least one of a criterium including a CC index, a CC channel quality, and intersection of uplink or downlink (UL/DL) CC.

4. The method of claim 1, wherein the channel measurements on a CC are associated with an indicator related to a channel quality of the CC.

5. The method of claim 1, wherein the channel measurements on a CC are based on at least one of a signal to noise ratio (SNR), a reference signal received power (RSRP), a signal-to-noise and interference (SINR), a throughput, a bit error rate, a block error rate, an interference power, a noise power, a beamforming gain, a mutual information, a receive signal strength indicator (RSSI), a reference signal received quality (RSRQ), and a received signal code power (RSCP).

6. The method of claim 1, wherein the carrier weight factor of a corresponding CC is based on a number of received BM-RS resource elements (REs) of the corresponding CC.

7. The method of claim 1, wherein the carrier weight factor of a corresponding CC is based on a number of received Physical Downlink Shared Channel (PDSCH) Demodulation Reference Signal (DMRS) resource elements (REs) of the corresponding CC.

8. The method of claim 1, wherein the carrier weight factor of a corresponding CC is based on a signal to noise ratio (SNR) or a reference signal received power (RSRP) of the correspond CC.

9. The method of claim 1, wherein the carrier weight factor of a corresponding CC is based on an indicator related to a channel quality of the corresponding CC.

10. The method of claim 1, wherein the beam vector is an Antenna Weight Vector (AWV) to be applied for the antenna array.

11. A transceiver, comprising:
a first transceiver that receives a beam management reference signal (BM-RS) transmitted from a second transceiver for reference signal measurements, wherein the first transceiver comprises an antenna array applied with analog beamforming;
a channel measurement circuit that performs channel measurements based on the received BM-RS for multiple component carriers (CCs) under carrier aggregation;
a beamforming circuit that derives a beam vector from the channel measurements over a set of selected CCs, wherein the beam vector is obtained from the combined channel measurements for the set of selected CCs applied with a carrier weight factor of a corresponding CC; and
the antenna array that applies the beam vector in subsequence data reception or transmission by the first transceiver.

12. The transceiver of claim 11, wherein the BM-RS is one of a synchronization signal (SS) block (SSB), a channel state information reference signal (CSI-RS), a CSI-RS for tracking, a Physical Downlink Shared Channel (PDSCH) Demodulation Reference Signal (DMRS), and a Physical Uplink Shared Channel (PUSCH) DMRS.

13. The transceiver of claim 11, wherein the set of selected CCs is based on at least one of a criterium including a CC index, a CC channel quality, and intersection of uplink or downlink (UL/DL) CC.

14. The transceiver of claim 11, wherein the channel measurements on a CC are associated with an indicator related to a channel quality of the CC.

15. The transceiver of claim 11, wherein the channel measurements on a CC are based on at least one of a signal to noise ratio (SNR), a reference signal received power (RSRP), a signal-to-noise and interference (SINR), a throughput, a bit error rate, a block error rate, an interference power, a noise power, a beamforming gain, a mutual information, a receive signal strength indicator (RSSI), a reference signal received quality (RSRQ), and a received signal code power (RSCP).

16. The transceiver of claim 11, wherein the carrier weight factor of a corresponding CC is based on a number of received BM-RS resource elements (REs) of the corresponding CC.

17. The transceiver of claim 11, wherein the carrier weight factor of a corresponding CC is based on a number of received Physical Downlink Shared Channel (PDSCH) Demodulation Reference Signal (DMRS) resource elements (REs) of the corresponding CC.

18. The transceiver of claim 11, wherein the carrier weight factor of a corresponding CC is based on a signal to noise ratio (SNR) or a reference signal received power (RSRP) of the correspond CC.

19. The transceiver of claim 11, wherein the carrier weight factor of a corresponding CC is based on an indicator related to a channel quality of the corresponding CC.

20. The transceiver of claim 11, wherein the beam vector is an Antenna Weight Vector (AWV) to be applied for the antenna array.
